(19) United States
(12) Patent Application Publication
(10) Pub. No.: US 2015/0327229 A1
(43) Pub. Date: Nov. 12, 2015

(54) METHOD AND APPARATUS FOR UPLINK SCHEDULING IN WIRELESS COMMUNICATION SYSTEM

(71) Applicant: Samsung Electronics Co., Ltd., Suwon-si, Gyeonggi-do (KR)

(72) Inventors: Shichang ZHANG, Beijing (CN); Chengjun SUN, Beijing (CN); Yingyang LI, Beijing (CN); Jingxing FU, Beijing (CN)

(21) Appl. No.: 14/410,247

(22) PCT Filed: Jun. 21, 2013
(86) PCT No.: PCT/KR2013/005512

§ 371 Date: Dec. 22, 2014

(30) Foreign Application Priority Data
Jun. 21, 2012 (CN) 201210212317.2

(51) Int. Cl. H04W 72/04; H04L 5/14; H04L 1/18

(52) U.S. Cl. CPC H04W 72/0406; H04L 1/1896; H04L 1/1854; H04L 5/14; H04W 88/02

(57) ABSTRACT

Provided is a method for performing an uplink scheduling by an evolved Node B (eNB) in a wireless communication system that includes sending signaling information to User Equipment (UE) including synchronous Hybrid Automatic Repeat request (HARQ) timing information of Physical Uplink Shared Channel (PUSCH), with the synchronous HARQ timing information determined based on information of grouping of uplink and downlink configurations and receiving PUSCH information sent by the UE based on timing information. The transmission of PUSCH in a dynamic TDD system can be effectively regulated, and the UE can identify the group of current configurations by receiving signaling, determining synchronous HARQ timing relation of scheduled PUSCH to implement scheduling of PUSCH in a dynamic TDD system with minor modification of the system.

### TECHNICAL FIELD

The present invention relates to mobile communication field, in particular, to the method and device for uplink scheduling.

### BACKGROUND ART

Long term evolution (LTE) has two duplexing modes, i.e., frequency division duplexing (FDD) and time division duplexing (TDD). FIG. 1 is the schematic diagram of the frame structure in TDD system of LTE. The length of every radio frame(100) is 10 ms, equally divided into two half-frame(101)s of 5 ms, each comprising 8 time slots of 0.5 ms and 3 special fields of total length of 1 ms. The 3 special fields are respectively downlink pilot time slot (DwPTS, 111), guard period (GP, 113) and uplink pilot time slot (UpPTS, 115), and each sub-frame consists of two continuous time slots.

In a TDD system, there are transmissions from eNBs to user equipments (UE) (referred as downlink) and the ones from user equipments to eNBs (referred to as uplink). In the frame structure shown in FIG. 1, 10 sub-frames are shared between uplink and downlink within 10 ms, each sub-frame is either configured to uplink or downlink, the sub-frame configured to uplink is referred to as uplink sub-frame, and the sub-frame configured to downlink as downlink sub-frame. A TDD system supports seven types of uplink and downlink configurations, as shown in FIG. 1, D represents downlink sub-frame, U represents uplink sub-frame, and S represents the special sub-frame(110) containing 3 special fields.

TABLE 1

| Configura- | Transition | | Sub-frame index | | | | | | | | | |
|---|---|---|---|---|---|---|---|---|---|---|---|---|
| tion No. | period | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 10 | ms | D | S | U | U | U | D | S | U | U | D |

Table 1 uplink and downlink configuration table

The TDD system of LTE supports HARQ mechanism, and its principle comprises: eNB allocating uplink resource to UE; UE sending uplink data to eNB using uplink resources; eNB receiving uplink data by and sending HARQ indication to UE, UE retransmitting uplink and downlink data based on the indication. In particular, UE carries uplink data via PUSCH, and eNB carries the PUSCH scheduling and control information via physical downlink control channel (PDCCH, Physical Downlink Control Channel), namely uplink grant (UL grant), eNB retransmits the indication carried by HARQ via physical hybrid retransmission indicator channel. In the above process, the timing position and subsequent retransmition timing position in one transmission of PUSCH are determined based on predefined timing relations, including the timing relations from UL Grant to PUSCH, from PHICH to PUSCH, and from PUSCH to PHICH, which hereinafter collectively referred to as synchronous HARQ timing relation of PUSCH.

Firstly, the timing relations between UL Grant or PHICH in LTE and LTE-A and PUSCH is as follows:

For the timing relation from UL Grant to PUSCH, it is assumed that UE receives UL grant in downlink sub-frame n (n is the index of sub-frame, similarly hereinafter), this UL grant is used to control the PUSCH in uplink sub-frame n+k, where the value of k is defined in Table 2. Specifically, for TDD uplink and downlink configurations (or simply called UL/DL configurations) 1-6, the number of uplink sub-frames is less than or equal to that of downlink sub-frames (frame S can be used as downlink sub-frame). For any downlink sub-frame n, the unique timing relation of synchronous HARQ of PUSCH can be configured via a unique k, as shown in Table 2. It is possible that PUSCH in one downlink sub-frame is not scheduled, or PUSCH in one uplink sub-frame can only be scheduled. For TDD UL/DL configuration 0, the number of uplink sub-frames is greater than that of downlink sub-frames. PDCCH in each downlink sub-frame needs to schedule the PUSCH in two uplink sub-frames, to this end, k is not unique. Uplink index is used in PDCCH to schedule the PUSCH in two uplink sub-frames, and different k is used for PUSCH with different indexes. For example, when UE received PDCCH in downlink sub-frame 0, what is scheduled by UE is the PUSCH in uplink sub-frame 4 and/or uplink sub-frame 7, and when UE received PDCCH in downlink sub-frame 1, what is scheduled by UE is the PUSCH in uplink sub-frame 7 and/or uplink sub-frame 8.

For the timing relation from PHICH to PUSCH, PHICH resource set is dependently allocated for PUSCH in uplink sub-frame in LTE and LTE-A. Assuming that UE received PHICH in downlink sub-frame n, this PHICH is then used to control PUSCH in uplink sub-frame n+j, where j is defined in Table 2. Specifically, for TDD UL/DL configurations 1-6, the number of uplink sub-frames is less than or equal to that of downlink sub-frames. For any one of downlink sub-frame n, the unique timing relation of synchronous HARQ of PUSCH can be configured via a unique j, as shown in Table 2. Different PHICH resource sets can be configured in one downlink sub-frame, or only PHICH resource set in uplink sub-frame can be configured. For TDD UL/DL configuration 0, the number of uplink sub-frames is greater than that of downlink sub-frames, and j is not unique. Two PHICH resource sets are configured in downlink sub-frames 0 and 5, namely PHICH resource 0 and PHICH resource 1, and for different PHICH resource, different j is used. For example, when UE received PHICH in downlink sub-frame 0, PUSCH in uplink sub-frame 4 and/or uplink sub-frame 7 can be triggered.

TABLE 2

| Configura- | Sub-frame index n | | | | | | | | | |
|---|---|---|---|---|---|---|---|---|---|---|
| tion No. | 0 | 1 | 2 | 3 | 4 | 5 | 6 | 7 | 8 | 9 |
| 0 | 4, 7 | 6, 7 | | | | 4, 7 | 6, 7 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

Table 2 timing relation table from UL-Grant/PHICH to PUSCH

Secondly, the timing relation from PUSCH in LTE and LTE-A to PHICH is as follows:

For TDD UL/DL configurations 1-6, when UE received PHICH in downlink sub-frame n, this PHICH indicates the HARQ-ACK of PUSCH in uplink sub-frame n-h, the values of h is shown in Table 3.

For TDD UL/DL configuration 0, when UE received PHICH in PHICH resource 0 in downlink sub-frame n, this PHICH controls PUSCH in uplink sub-frame n-h based on the definition of h in Table 3, since two PHICH resources are configured. Whereas, when UE received PHICH in PHICH resource 1 in downlink sub-frame 0 or 5, this PHICH controls the transmission of PUSCH in uplink sub-frame n−6.

TABLE 3

| Configura- | downlink sub-frame index n | | | | | | | | | |
|---|---|---|---|---|---|---|---|---|---|---|
| tion No. | 0 | 1 | 2 | 3 | 4 | 5 | 6 | 7 | 8 | 9 |
| 0 | 7 | 4 | | | | 7 | 4 | | | |
| 1 | | 4 | | | 6 | | 4 | | | 6 |
| 2 | | | | 6 | | | | | 6 | |
| 3 | 6 | | | | | | | | 6 | 6 |
| 4 | | | | | | | | | 6 | 6 |
| 5 | | | | | | | | | 6 | |
| 6 | 6 | 4 | | | | 7 | 4 | | | 6 |

Table 3 timing relation table from PUSCH to PHICH

Based on above 3 timing relation tables (Tables 2 and 3), one can determine the synchronous HARQ timing relation of PUSCH when a cell uses a certain TDD UL/DL configurations, so as to implement synchronous transmission according to this synchronous HARQ timing relation of PUSCH.

As users are increasing the demand for higher data transmission rate, an advanced LTE technology (LTE-A) is proposed. In LTE-A, by dynamic TDD technology, i.e., configuring the UL/DL in TDD via physical layer signaling, the proportion of uplink sub-frame and downlink sub-frame conforms to that of uplink throughput and downlink throughput, facilitating the rise in UL/DL peak rate and system throughput.

For a dynamic TDD system, TDD UL/DL configuration in a cell dynamically changes with the current UL/DL throughputs. In terms of existing LTE and LTE-A protocol, UE obtains the UL/DL configuration in the cell through broadcast system information, and further obtains synchronous HARQ timing relation of PUSCH based on Tables 2 and 3 by using TDD configuration an index. But in the scene of a dynamic TDD, fast switching between TDD UL/DL configuration is required, while in terms of existing protocol in LTE and LTE-A, the short refreshing period of system information is 640 ms. As a result, in terms of the method of existing protocol in LTE and LTE-A, in which the change in UE UL/DL configuration is indicated via system information so as to acquire synchronous HARQ timing relation of PUSCH, the switching period of TDD configurations will be very long.

### DISCLOSURE OF INVENTION

### Technical Problem

Obviously, for a dynamic TDD system, synchronous HARQ timing relation of PUSCH cannot be derived through TDD UL/DL configuration in existing method. Therefore, there is a need for efficient technical solution to address the uplink scheduling issue of a dynamic TDD system.

### Solution to Problem

Accordingly, the present invention has been made to solve the above-mentioned problems occurring in the prior art, and the present invention provides a method and an apparatus for performing an uplink scheduling in a wireless communication system.

In accordance with an aspect of the present invention, there is provided a method for performing an uplink scheduling by an evolved Node B (eNB) in a wireless communication system, the method comprises sending signaling information to a User Equipment (UE), the signaling information including synchronous Hybrid Automatic Repeat request (HARQ) timing information of Physical Uplink Shared Channel (PUSCH), wherein the synchronous HARQ timing information is determined based on information of grouping of uplink and downlink configurations, and receiving PUSCH information sent by the UE.

In accordance with another aspect of the present invention, there is provided a method for performing an uplink scheduling by a User Equipment (UE) in a wireless communication system, the method comprises receiving signaling information sent by an evolved Node B (eNB), the signaling information including synchronous Hybrid Automatic Repeat request (HARQ) timing information of Physical Uplink Shared Channel (PUSCH), wherein the synchronous HARQ timing information is determined based on information of grouping of uplink and downlink configurations, and sending PUSCH information to the eNB.

In accordance with further aspect of the present invention, there is provided an evolved Node B (eNB) for performing an uplink scheduling in a wireless communication system, the eNB comprises a transceiver for transmitting/receiving data over a wireless network, and a controller for controlling operations of sending signaling information to a User Equipment (UE), the signaling information including synchronous Hybrid Automatic Repeat request (HARQ) timing information of Physical Uplink Shared Channel (PUSCH), wherein the synchronous HARQ timing information is determined based on information of grouping of uplink and downlink configurations, and receiving PUSCH information sent by the UE.

In accordance with further still aspect of the present invention, there is provided a User Equipment (UE) for performing an uplink scheduling in a wireless communication system, the UE comprises a transceiver for transmitting/receiving data over a wireless network, and a controller for controlling operations of receiving signaling information sent by an evolved Node B (eNB), the signaling information including synchronous Hybrid Automatic Repeat request (HARQ) timing information of Physical Uplink Shared Channel (PUSCH), wherein the synchronous HARQ timing information is determined based on information of grouping of uplink and downlink configurations, and sending PUSCH information to the eNB.

In the technical solution of the present invention, 7 TDD UL/DL configurations, defined in existing LTE/LTE-A, are grouped based on the period of round trip time (RTT) of PUSCH or other criteria. eNB schedules PUSCH via signaling, and meantime indicates the current grouping information to UE; UE determines the scheduled synchronous HARQ timing relation of PUSCH with reference to synchronous HARQ timing relation of PUSCH of TDD UL/DL configurations in the group. The information of existing 7 UL/DL configurations after being grouped by the present invention is only to indicate to UE synchronous HARQ timing relation of PUSCH, not to limit UL/DL sub-frames working in the current system. In the case that UE acquires the information about the scheduling of PUSCH and grouping of current TDD UL/DL configurations by the signaling sent by eNB, even if the UL/DL sub-frames of TDD UL/DL configurations current in the system are different than that of any of the groups, UE is able to determine synchronous HARQ timing relation of PUSCH being scheduled based on synchronous HARQ timing relation of PUSCH of TDD UL/DL configurations in the group and the method of present invention.

### Advantageous Effects of Invention

In the technical solution of the present invention, the transmission of PUSCH in a dynamic TDD system can effectively regulated, and UE can identify the group of current configurations by receiving signaling, whereby determine synchronous HARQ timing relation of PUSCH being scheduled. The solution of the present invention can achieve the scheduling of PUSCH in a dynamic TDD system with minor modification of the system. Furthermore, the above mentioned solution of the present invention has minimum change to the existing system, will not compromise the compatibility of the system, and is efficient and easy to achieve.

The additional aspects and advantages of the present invention will be given in the following description, which will be apparent from the description or by practicing the present invention.

### BRIEF DESCRIPTION OF DRAWINGS

The above and additional aspects and advantages will be apparent and easy to understand from the following descriptions of the embodiments taken in combination with the drawings, wherein

FIG. 1 is the schematic drawing of the frame structure of a TDD system of LTE;

FIG. 2 is the flowchart of uplink scheduling method in the network side of the embodiment of the present invention;

FIG. 3 is the schematic drawings of the uplink scheduling method in the UE side of the embodiment of the present invention;

FIG. 4 is the schematic drawing 1 of synchronous HARQ timing relation of PUSCH determined by the bit value of UL-Index or UL-DAI in UL-Grant and the position of UL-Grant;

FIG. 5 is the schematic drawing 2 of synchronous HARQ timing relation of PUSCH determined by the bit value of UL-Index or UL-DAI in UL-Grant and the position of UL-Grant;

FIG. 6 is the schematic drawing of synchronous HARQ timing relation of PUSCH determined by the position of UL-Grant;

FIG. 7 is the schematic drawing of synchronous HARQ timing relation scheduling of PUSCH obtained by modifying TDD UL/DL configuration 0.

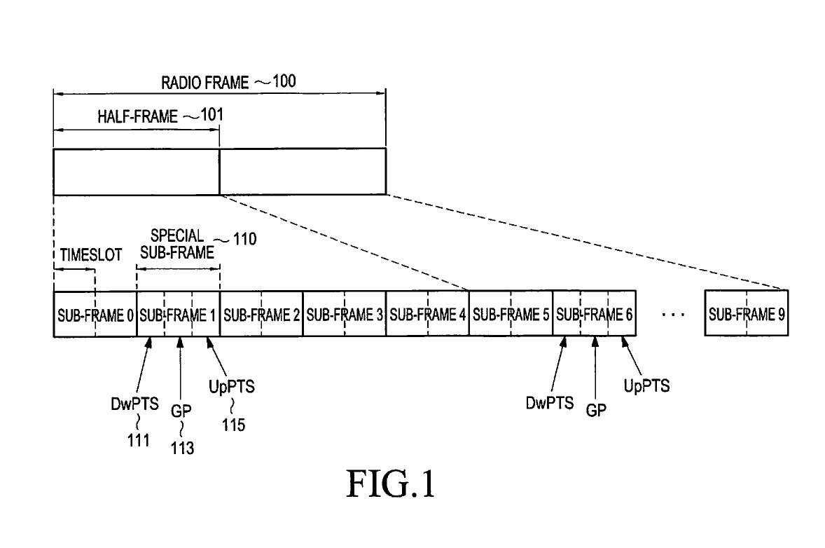

### MODE FOR THE INVENTION

In the following, the embodiments of the present invention will be described in detail, and the examples of the embodiment are shown in drawings, wherein same or similar reference signs indicate same or similar elements or the ones with same or similar functions throughout. The embodiments to be described hereinafter with reference to the drawings are schematic, and only to explain the present invention, not to be considered as a limitation to the present invention.

The present invention mainly relates to a dynamic TDD scene. In this scene, TDD UL/DL configurations can be dynamically changed via controlling signaling of physical layers as the UL/DL throughputs in a cell dynamically change. According to the existing LTE and LTE-A protocols, the shortest refresh period is 640 ms and the switching period of TDD configuration is very long by using the method of informing the changes in UE UL/DL configurations via system messages, then obtaining synchronous HARQ timing relation of PUSCH.

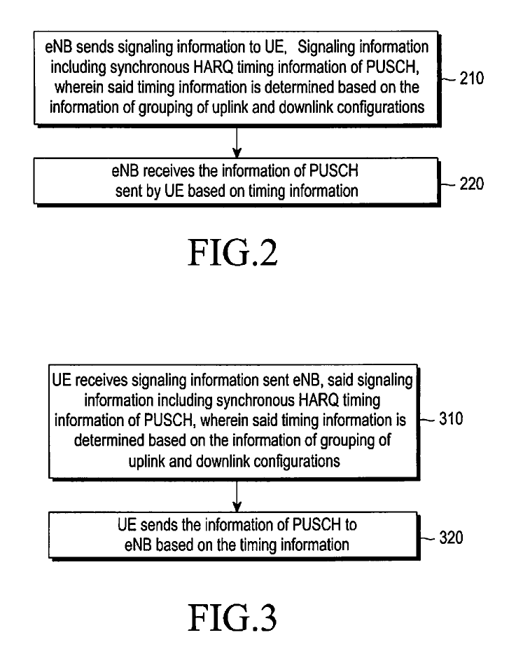

To achieve the object of the present invention, the embodiment of the present invention provides an uplink scheduling method, as shown in FIG. 2, including the following steps:

210: eNB sends signaling information to UE, said signaling information including synchronous HARQ timing information of PUSCH, wherein said timing information is determined based on the information of groups of UL/DL configurations.

In particular, eNB sends signaling information to a UE, said signaling information including synchronous HARQ timing information of physical uplink shared channel (PUSCH), wherein said timing information is determined based on the information of groups of UL/DL configurations.

The grouping of UL/DL configurations include grouping the UL/DL configurations based on the features of TDD UL/DL configurations, particularly the period of PUSCH Round Trip Time (PUSCH RTT). Therefore, UL/DL configurations can be reasonably grouped or combined as needed. The examples of the groups in the following are only part of the implementations.

Furthermore, for example, UL/DL configuration groups include any one of the following options:

Option A: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, and second group of TDD UL/DL configurations 0 and 6 with RTT not being 10 ms;

Option B: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, second group of TDD UL/DL configuration 0 with RTT not being 10 ms; and third group of TDD UL/DL configuration 6 with RTT not being 10 ms;

Option C: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, and second group of TDD UL/DL configuration 0 with RTT not being 10 ms. In this method, the system is not able to dynamically set TDD UL/DL configuration to TDD UL/DL configuration 6.

Option D: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, and second group of TDD UL/DL configuration 6 with RTT not being 10 ms. In this method, the system is not able to dynamically set TDD UL/DL configuration to TDD UL/DL configuration 0.

As an implementation of the present invention, eNB indicates the information of groups based on predefined grouping method and the bit values of UL-Index or UL-DAI in UL-Grant in respective sub-frames. For example, in the Option C, eNB indicates the information of groups via the bit values of UL-Index or UL-DAI in UL-Grant in sub-frames 0, 1 and 6.

For Options A, B or C:

When the bit value is “00”, it means that current TDD UL/DL configuration is the first group;

When the bit values is “00”, “10” or “11”, it means that current TDD UL/DL configuration is the second group.

For Option D:

When the bit values is “01”, “01” or “10”, it means that current TDD UL/DL configuration is the first group;

When the bit value is “11”, it means that current TDD UL/DL configuration is the second group.

Additionally, eNB is also able to indicate the information of groups with 2 bits in TPC command in DCI format 0 or with additional 2 bits in DCI 0.

220: eNB receives PUSCH information sent by UE based on the timing information.

Subsequently, eNB receives PUSCH information sent by UE based on the timing information.

As shown in FIG. 3, the embodiment of the present invention also provides an uplink scheduling method in the terminal side, including the following steps:

310: UE receives signaling information sent by eNB, said signaling information including synchronous HARQ timing information of PUSCH, wherein said timing information is determined based on the information of groups of UL/DL configurations.

UE receives the signaling information sent by eNB, said signaling information including synchronous HARQ timing information of physical uplink shared channel (PUSCH), wherein said timing information is determined based on the information of groups of UL/DL configurations;

The grouping of UL/DL configurations include grouping the UL/DL configurations based on the period of PUSCH Round Trip Time (PUSCH RTT) of TDD UL/DL configurations. Therefore, UL/DL configurations can be reasonably grouped or combined as needed. The examples of the groups in the following are only part of the implementations.

For example, UL/DL configuration groups include any one of the following options:

Option A: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, and second group of TDD UL/DL configurations 0 and 6 with RTT not being 10 ms;

Option B: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, second group of TDD UL/DL configuration 0 with RTT not being 10 ms; and third group of TDD UL/DL configuration 6 with RTT not being 10 ms;

Option C: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, and second group of TDD UL/DL configuration 0 with RTT not being 10 ms. In this method, the system is not able to dynamically set TDD UL/DL configuration to TDD UL/DL configuration 6.

Option D: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, and second group of TDD UL/DL configuration 6 with RTT not being 10 ms. In this method, the system is not able to dynamically set TDD UL/DL configuration to TDD UL/DL configuration 0.

As an implementation of the present invention, UE receives the signaling information sent by eNB, and determines the current information of groups based on predefined grouping method and the bit values of UL-Index or UL-DAI in UL-Grant in respective sub-frames. For example, in the Option C, UE determines the group to which current uplink HARQ process belongs by the bit values of UL-Index or UL-DAI in UL-Grant in sub-frames 0, 1 and 6:

When the bit value is “00”, it means that current TDD UL/DL configuration is the first group;

When the bit values is “01”, “10” or “11”, it means that current TDD UL/DL configuration is the second group.

Additionally, UE receives the information sent by eNB, and is also able to indicate the information of groups with 2 bits in TPC command in DCI format 0 or with additional 2 bits in DCI format 0.

320: UE sends PUSCH information to eNB based on the timing information.

Subsequently, UE sends PUSCH information to eNB based on the timing information.

Corresponding to the above method, the embodiment of the present invention also provides a eNB, including a transceiver comprising a transmitting module and a receiving module.

In an alternative embodiment, the eNB can be configured to comprise a transceiver for transmitting/receiving data over a wireless network, and a controller for performing functions of the transmitting module and the receiving module by using the transceiver.

In particular, the transmitting module is used to send signaling information to the terminal UE, said signaling information including synchronous HARQ timing information of physical uplink shared channel (PUSCH), wherein said timing information is determined based on the information of groups of UL/DL configurations.

In the above device, the grouping of UL/DL configurations include grouping the UL/DL configurations based on the period of PUSCH Round Trip Time (PUSCH RTT).

UL/DL configuration groups include any one of the following options:

Option A: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, and second group of TDD UL/DL configurations 0 and 6 with RTT not being 10 ms;

Option B: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, second group of TDD UL/DL configuration 0 with RTT not being 10 ms; and third group of TDD UL/DL configuration 6 with RTT not being 10 ms;

Option C: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, and second group of TDD UL/DL configuration 0 with RTT not being 10 ms. In this method, the system is not able to dynamically set TDD UL/DL configuration to TDD UL/DL configuration 6.

Option D: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, and second group of TDD UL/DL configuration 6 with RTT not being 10 ms. In this method, the system is not able to dynamically set TDD UL/DL configuration to TDD UL/DL configuration 0.

As an implementation of the present invention, transmitting module 110 indicates the information of groups based on predefined grouping method and the bit values of UL-Index or UL-DAI in UL-Grant in respective sub-frames. For example, in the Options A, B or C, transmitting module 110 indicates the information of groups via the bit values of UL-Index or UL-DAI in UL-Grant in sub-frames 0, 1 and 6:

When the bit value is “00”, it means that current TDD UL/DL configuration is the first group;

When the bit values is “00”, “10” or “11”, it means that current TDD UL/DL configuration is the second group.

For Option D:

When the bit values is “01”, “01” or “10”, it means that current TDD UL/DL configuration is the first group;

When the bit value is “11”, it means that current TDD UL/DL configuration is the second group.

The transmitting module in the eNB indicates the information of groups with 2 bits in TPC command in DCI format 0 or with additional 2 bits in DCI format 0.

The receiving module in the eNB is used to receive PUSCH information sent by UE based on the timing information.

Corresponding to the above method, the embodiment of the present invention also provides a UE, including a transceiver comprising a receiving module and a transmitting module. In an alternative embodiment, the UE can be configured to comprise a transceiver for transmitting/receiving data over a wireless network, and a controller for performing functions of the transmitting module and the receiving module by using the transceiver.

In particular, the receiving module in the UE is used to receive signaling information sent by the eNB, said signaling information including synchronous HARQ timing information of physical uplink shared channel (PUSCH), wherein said timing information is determined based on the information of groups of UL/DL configurations.

The grouping of UL/DL configurations include grouping the UL/DL configurations based on the period of PUSCH Round Trip Time (PUSCH RTT).

UL/DL configuration groups include any one of the following options:

Option A: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, and second group of TDD UL/DL configurations 0 and 6 with RTT not being 10 ms;

Option B: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, second group of TDD UL/DL configuration 0 with RTT not being 10 ms; and third group of TDD UL/DL configuration 6 with RTT not being 10 ms;

Option C: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, and second group of TDD UL/DL configuration 0 with RTT not being 10 ms. In this method, the system is not able to dynamically set TDD UL/DL configuration to TDD UL/DL configuration 6.

Option D: based on the period of Round Trip Time (RTT) of PUSCH, grouping the 7 TDD UL/DL configurations in LTE and LTE-A into first group of TDD UL/DL configurations 1, 2, 3, 4, and 5 with 10 ms of RTT, and second group of TDD UL/DL configuration 6 with RTT not being 10 ms. In this method, the system is not able to dynamically set TDD UL/DL configuration to TDD UL/DL configuration 0.

As an implementation of the present invention, receiving module 210 receives the signaling information sent by eNB, and determines the information of groups based on predefined grouping method and the bit values of UL-Index or UL-DAI in UL-Grant in respective sub-frames. For example, in the Options A, B or C, receiving module 210 receives UL-Grant in sub-frames 0, 1 and 6, determines the group to which current uplink HARQ process belongs by the bit values of UL-Index or UL-DAI in UL-Grant:

When the bit value is “00”, it means that current TDD UL/DL configuration is the first group;

When the bit values is “01”, “10” or “11”, it means that current TDD UL/DL configuration is the second group.

For Option D:

When the bit values is “01”, “01” or “10”, it means that current TDD UL/DL configuration is the first group;

When the bit value is “11”, it means that current TDD UL/DL configuration is the second group.

The receiving module receives the information sent by eNB, and determines the information of groups with 2 bits in TPC command in DCI format 0 or with additional 2 bits in DCI format 0.

The transmitting module is used to send PUSCH information to eNB based on the timing information.

In the technical solutions of the present invention, the transmission of PUSCH in a dynamic TDD system can be effectively regulated, and UE can identify the group of current configurations by receiving signaling, whereby determine synchronous HARQ timing relation of PUSCH being scheduled. The solutions of the present invention can achieve the scheduling of PUSCH in a dynamic TDD system with minor modification of the system. Furthermore, the above mentioned solutions of the present invention have minimum changes to the existing system, will not compromise the compatibility of the system, and are efficient and easy to achieve.

To facilitate understanding of the present invention, the method or device of the present invention disclosed in the above will be further explained in combination with specific application in an interactive way between devices as follows:

Step 301: grouping 7 TDD UL/DL configurations in LTE and LTE-A into different groups to determine synchronous HARQ timing information of PUSCH;

Step 302: UE identifies which group the current configurations belong to after receiving the signaling sent by eNB, and acquires synchronous HARQ timing relation of PUSCH based on this grouping information;

Step 303: UE sends PUSCH, and receives PHICH based on the timing relation of PUSCH determined by Step 302.

In Step 301, Implementation 1 of grouping the 7 TDD UL/DL configurations in LTE and LTE-A into different groups is to group into two groups based on the period of Round Trip Time (RTT) of PUSCH being 10 ms or not, that is, grouping into one group of TDD UL/DL configurations 1, 2, 3, 4, and 5 with 10 ms of RTT, and another group of TDD UL/DL configurations 0 and 6 with RTT not being 10 ms;

In Step 301, Implementation 2 of grouping the 7 TDD UL/DL configurations in LTE and LTE-A into different groups is to group based on the period of Round Trip Time (RTT) of PUSCH, that is, grouping into first group of TDD UL/DL configurations 1, 2, 3, 4, and 5 with 10 ms of RTT, second group of TDD UL/DL configuration 0; and third group of TDD UL/DL configuration 6;

In Step 301, Implementation 3 of grouping the 7 TDD UL/DL configurations in LTE and LTE-A into different groups is to group them into two groups, that is, grouping into first group of TDD UL/DL configurations 1, 2, 3, 4, and 5 with 10 ms of RTT, second group of TDD UL/DL configuration 0. In this method, the system is not able to dynamically set TDD UL/DL configuration to TDD UL/DL configuration 6. Said dynamic TDD UL/DL configurations mean to configure them via physical layer signaling.

In Step 301, Implementation 4 of grouping the 7 TDD UL/DL configurations in LTE and LTE-A into different groups is to group them into two groups, that is, the first group of TDD UL/DL configurations 1, 2, 3, 4, and 5 with 10 ms of RTT, and second group of TDD UL/DL configuration 6. In this method, the system is not able to dynamically set TDD UL/DL configuration to TDD UL/DL configuration 6.

One implementation of Step 302 is that UE determine which group current configurations belong to by the received position of UL-Grant or bit values of UL-Index or UL-DAI in UL-Grant or combination thereof;

Another implementation of Step 302 is to indicate which group current configurations belong to by defining new downlink control information (DCI) format or adding new bits in existing UL-Grant format;

Another implementation of Step 302 is to indicate which group current configurations belong to by redefining some fields or padding bits in the existing DCI format, and others.

For 10 ms of PUSCH RTT period, UE can determine synchronous HARQ timing relation of PUSCH based on the signaling position sent by eNB, for example, the position of UL-Grant, since the position of each UL-Grant has same position separation as that of PUSCH being scheduled. For the PUSCH RTT period of not being 10 ms, UE needs to determine whether to allocate configuration 0 or 6 based on a certain scheme, then determine to use synchronous HARQ timing relation of PUSCH of configuration 0 or 6. Said scheme has some connection with the method in step 301, and UE will determine to allocate configuration 0 or 6 according to this grouping method and the signaling sent by eNB. For example, if Option C is used, UE received the information indicating the second group, i.e., the group of configuration 0, UE will determine that it is configuration 0.

The method according to the present invention is implemented as follows as an application scene 1:

For the PUSCH RTT period of not being 10 ms, TDD UL/DL configuration 0 is used rather than configuration 6, since uplink/downlink ratio of configuration 6 can be obtained by averaging configuration 0 and other configurations with high downlink/uplink radio in time. UE detects PDCCH with UL-Grant in all downlink sub-frames possibly having UL-Grant. If UL-Grant is detected to be sub-frames #0, #1, or #6, then synchronous HARQ timing relation of PUSCH being scheduled is determined based on the bit values of UL-Index or UL-DAI in UL-Grant and the position of UL-Grant; and if UL-Grant is detected to be sub-frames other than sub-frames 0, 1, or 6, then synchronous HARQ timing relation of PUSCH being scheduled is determined based on the position of UL-Grant in the sub-frame.

The further steps of above solution are for example as follows:

Step 401: configurations 0, 1, 2, 3, 4 and 5 in 7 TDD UL/DL configurations defined in LTE and LTE-A are grouped in Option C, that is:

Group 1: TDD UL/DL configuration 0;

Group 2: TDD UL/DL configurations 1, 2, 3, 4, and 5;

Step 402: Detecting PDCCH in all sub-frames possibly having uplink scheduling, and acquires UL-Grant, wherein, the sub-frames possibly having uplink scheduling mean sub-frames #0, #1, #3, #4, #5, #6, #8 and #9. If UL-Grant is in sub-frames #0, #1 and #6, then synchronous HARQ timing relation of PUSCH being scheduled is determined based on the bit values of UL-Index or UL-DAI in UL-Grant and the position of UL-Grant; and if UL-Grant is in the sub-frames other than sub-frames #0, #1 and #6, that is, sub-frames #3, #4, #5, #8 or #9, then synchronous HARQ timing relation of PUSCH being scheduled is determined based on the position of UL-Grant in the sub-frames, with following specific steps:

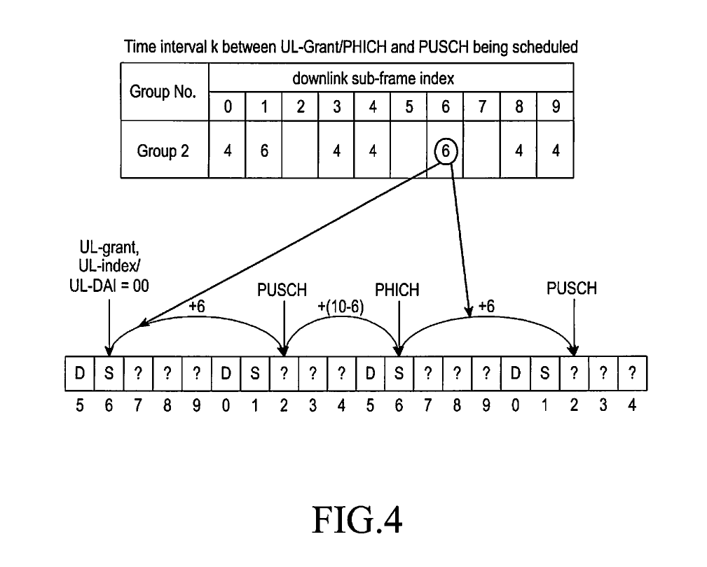

(1) The mapping relation table from UL-Grant/PHICH to PUSCH of group 2 is obtained by merging the parts of group 2 in Table 2, as shown in FIG. 4;

TABLE 4

| Group | downlink sub-frame Index n | | | | | | | | | |
|---|---|---|---|---|---|---|---|---|---|---|
| number | 0 | 1 | 2 | 3 | 4 | 5 | 6 | 7 | 8 | 9 |
| Group 2 | 4 | 6 | | 4 | 4 | | 6 | | 4 | 4 |

Table 4 the separation k from UL-Grant/PHICH sub-frame to PUSCH sub-frame of group 2

(2) Re-defining UL-Index or the bit value of UL-DAI in UL-Grant of sub-frames 0, 1 and 6 as follows:

If UL-Index or the bit value of UL-DAI is “00”, then current TDD UL/DL configuration is group 2, that is, TDD UL/DL configurations 1, 2, 3, 4 or 5;

If UL-Index or the bit value of UL-DAI is “01”, “10” or “11”, then current TDD UL/DL configuration is group 1, that is, TDD UL/DL configuration 0; above three bit values have same definitions as in LTE and LTE-A, indicating that the uplink sub-frames is being scheduled;

(3) If detecting UL-Grant in sub-frames 0, 1 or 6, then it is determined which group TDD UL/DL configurations in a cell belong to based on (2); If detecting UL-Grant in sub-frames 3, 4, 8 and 9, then it is determined to be group 2, If detecting UL-Grant in sub-frame 5, then it is determined to be group 1, and receives UL-Index in UL-Index or UL-DAI according to TDD UL/DL configuration 0 in LTE and LTE-A;

For group 1, the definition of synchronous HARQ timing relation of PUSCH is the same as that of configuration 0 in LTE and LTE-A, as shown in configuration 0 in Tables 2 and 3 in the Background part. For group 2, if detecting UL-Grant in sub-frame n, the scheduled PUSCH is transmitted in sub-frame n+k, and synchronous transmission of HARQ is carried in 10 ms of HARQ RTT, that is to say, PHICH is received in sub-frame n+10. If non-adaptive retransmission occurs to PUSCH, UE will transmit the mth non-adaptive retransmission in sub-frame n+10×m+k, and receive PHICH in the mth retransmissions in sub-frame n+10×(m+1), here, k is as in FIG. 4, 1≦m≦M, M is the maximum retransmission number defined by the system.

Step 403: the terminal sends PUSCH, and receives PHICH based on synchronous HARQ timing relation of PUSCH defined in Step 302.

Here, it can be a same HARQ process or different ones in which PUSCH is changed before and after the configuring of TDD according to the method of the present invention.

For example, If detecting UL-Grant in sub-frame 6, and the bit value of UL-Index or UL-DAI in UL-Grant is “00”, then UE determines that the TDD UL/DL configuration is group 2, and will send PUSCH in sub-frame (6+6), i.e., the sub-frame #2 of next frame based on Table 4, and receives PHICH in sub-frame (6+10). If PHICH gives NACK back, then the first retransmission will be sent in sub-frame (6+10+6), and so on, as shown in FIG. 4.

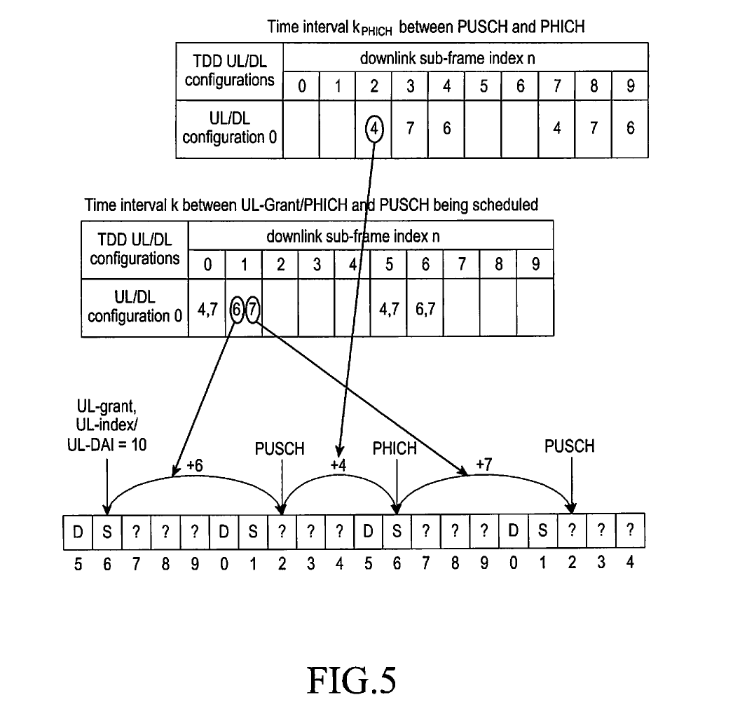

If detecting UL-Grant in sub-frame 6, and the bit value of UL-Index or UL-DAI in UL-Grant is “10”, then UE determines that the TDD UL/DL configuration is group 1, and will send PUSCH and receive PHICH based on synchronous HARQ timing relation of PUSCH of configuration 0 in LET and LET-A, as shown in FIG. 5.

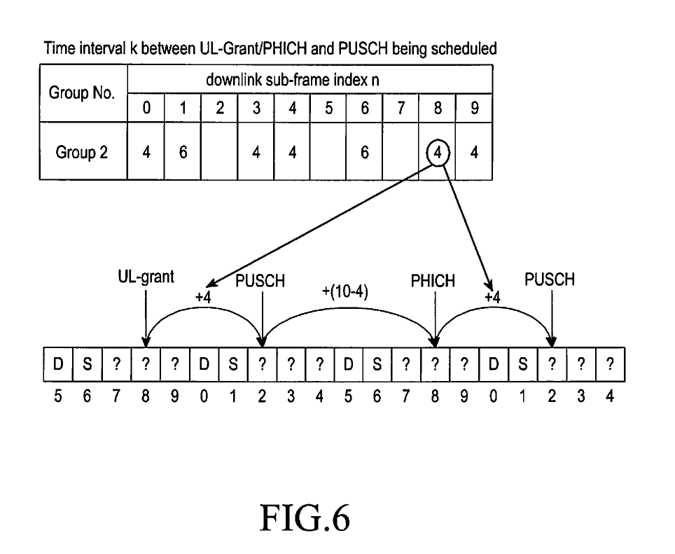

If detecting UL-Grant in sub-frame 8, then UE determines that the TDD UL/DL configuration is group 2, and will send PUSCH in sub-frame (8+4), and receives PHICH in sub-frame (8+10) based on Table 4. If PHICH gives NACK back, then the first retransmission will be sent in sub-frame (8+10+4), and so on, as shown in FIG. 6.

Another solution according to the present invention can also be implemented as follows as an application scene 2:

The 7 TDD UL/DL configurations defined in LTE and LTE-A are grouped in Option A, and the groups are determined based on the position of UL-Grant or the bit value of UL-Index or UL-DAI in UL-Grant or the combination thereof. If PUSCH RTT period with being not 10 ms and configuration 6 are used, the PUSCH of configuration 6 is scheduled by synchronous HARQ timing relation of configuration 0, and PUSCH will not be scheduled to sub-frame 9, particularly as follows:

Step 501: grouping in Option A, that is:

Group 1: TDD UL/DL configurations 0 and 6;

Group 2: TDD UL/DL configurations 1, 2, 3, 4, and 5;

Step 502: the groups are determined according to the method of scene 1.

If it's group 2, then synchronous HARQ timing relation of PUSCH is determined in the same way as in above embodiment.

If it's group 1, and UE detects UL-Grant or PHICH in sub-frames 0, 1 and 6, or UE detects UL-Grant with UL-Index≠00 or PHICH with I_{PHICH}=0 in sub-frame 5, then the timing relation from UL-Grant or PHICH to PUSCH is the same as the configuration 0 in LTE and LTE-A, as shown in sub-frames 0, 1, 5 and 6 of configuration 0 of Table 2 in the Background part.

If UE detects PHICH with I_{PHICH}=1 in sub-frame 5, and UE sent PUSCH in the sub-frame 9 of last frame, this PHICH is considered as the ACK/NACK indication of PUSCH of the sub-frame 9 of last frame, and will send the scheduled PUSCH in sub-frame 2 of next frame. If UE did not send PUSCH in sub-frame 9 of last frame, this PHICH is considered as the ACK/NACK indication of PUSCH of the sub-frame 8 of last frame, and will send the scheduled PUSCH in sub-frame 2 of next frame;

If UE detects UL-Grant with UL-Index=00 in sub-frame 5, it is considered that what is scheduling now is the PUSCH of sub-frame 8 of last frame, and UE should retransmit or transmit PUSCH of sub-frame 8 of last frame according to New Data Indication (NDI) value in UL-Grant.

In addition, the timing relations from PUSCH to PHICH of all uplink sub-frames are the same as that of configuration 0 in LTE and LTE-A, as shown in configuration 0 in Table 2 of Background part. UE should keep listening to PDCCH in sub-frame 9;

If it's group 1, and for eNB, it's TDD UL/DL configuration 6, I_{PHICH} of PHICH of uplink sub-frame 8 of last frame, which is present in sub-frame 5 by eNB has to be set to 1, and UL-Index of UL-Grant uplink sub-frame 8 of last frame, which is sent in sub-frame 5 has to be set to “00”. In addition, eNB can send downlink data in sub-frame 9.

Step 503: the same as Step 403 in application scene 1.

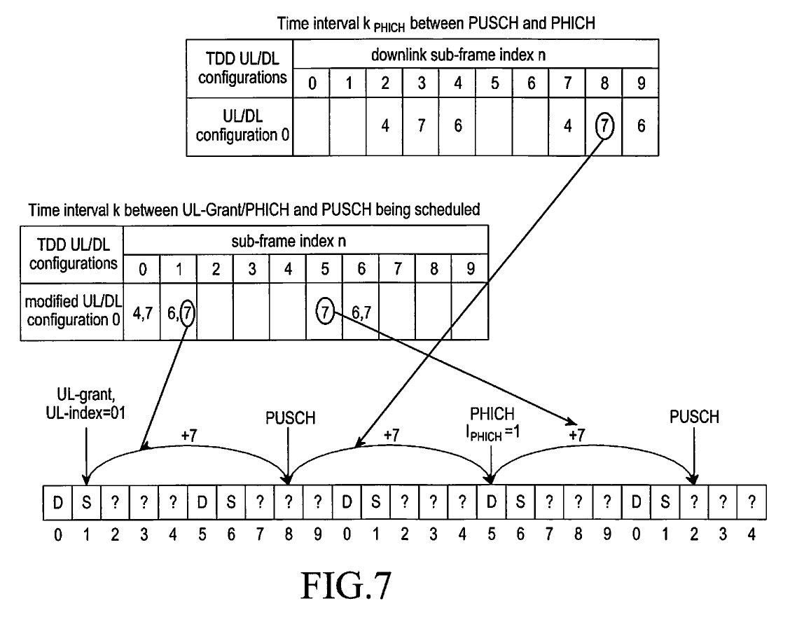

For example, if it's TDD UL/DL configuration 6, UE detects the “01” of UL-Index of UL-Grant in sub-frame 1, then UE sends PUSCH based on the timing relation from UL-Grant to PUSCH of TDD UL/DL configuration 0. Here I_{PHICH} can only equal to “1”, and this PUSCH will be scheduled to sub-frame 2 in the next frame, as shown in FIG. 7.

Another solution according to the present invention can also be implemented as follows as an application scene 3:

Step 601: grouping in Option B, that is:

Group1: TDD UL/DL configuration 0;

Group2: TDD UL/DL configuration 6;

Group3: TDD UL/DL configurations 1, 2, 3, 4, and 5;

Step 602: a new DCI format is defined based on DCI format 0 in LTE and LTE-A, adding two bits on all DCI format 0 (hereinafter referred as new bits). The groups are indicated by the values of new bits, for example, “00” indicates group 1, “01” indicates group 2, “10” indicates group 3. The current grouping is determined by the bit value of the newly defined DCI. If it's group 1 or 2, synchronous HARQ timing relation of PUSCH is the same as that of TDD UL/DL configuration 0 or 6 in LTE and LTE-A. If it's group 3, synchronous HARQ timing relation of PUSCH is determined in the same way as the Group 2 in application scene.

Step 603: the same as Step 403 in application scene 1.

Another solution according to the present invention can also be implemented as follows as an application scene 4:

The 7 TDD UL/DL configurations in LTE and LTE-A are grouped in Option B. UE detects PDCCH with UL-Grant in downlink sub-frames possibly having UL-Grant. If UL-Grant is in sub-frames #0, #1, #5, #6 and #9, then synchronous HARQ timing relation of PUSCH being scheduled is determined based on bit value of TPC in UL-Grant and the position of UL-Grant, and if in other sub-frames, it is determined based on the sub-frame position of UL-Grant, with specific steps as follows:

Step 701: grouping in Option B, that is:

Group 1: TDD UL/DL configuration 0;

Group2: TDD UL/DL configuration 6;

Group3: TDD UL/DL configurations 1, 2, 3, 4, and 5.

Step 702: UE detects PDCCH in the sub-frames possibly in uplink scheduling to acquire UL-Grant, here the possible sub-frames in uplink scheduling means #0, #1, #3, #4, #5, #6, #8 and #9. If UL-Grant is in sub-frames #0, #1, #5, #6 and #9, then synchronous HARQ timing relation of PUSCH being scheduled is determined based on bit value of TPC in UL-Grant and the position of UL-Grant, and if in other sub-frames, i.e., #3, #4 or #8, it is determined based on the sub-frame position of UL-Grant, with specific steps as follows:

(1) Specific sub-step (1) of Step 403

(2) defining the relation between TPC bit in UL-Grant in sub-frames 0, 1, 5, 6 and 9 and configuration groups, for example,

“00” corresponds to Group 1, “01” corresponds to Group2, “10” corresponds to Group3.

(3) If UE detects UL-Grant in sub-frames #0, #1, #5, #6 and #9, which group TDD UL/DL configuration in a cell belongs is determined based on above mentioned (2); if UE detects UL-Grant in sub-frames #3, #4, #8, then it's TDD UL/DL configuration 3.

(4) For Group 1 and 2, synchronous HARQ timing relation of PUSCH is same as that of configuration 0 in LTE and LTE-A, as shown in configurations 0 and 6 in Tables 2 and 3 in Background part. For Group 3, if UE detects UL-Grant in sub-frame n, the PUSCH being scheduled is sent in sub-frame n+k, and synchronous transmission of HARQ is carried in 10 ms of HARQ RTT, that is to say, PHICH is received in sub-frame n+10. If non-adaptive retransmission occurs to PUSCH, UE will transmit the mth non-adaptive retransmission in sub-frame n+10×m+k, and receive PHICH in the mth retransmissions in sub-frame n+10×(m+1), here, k is as in Table. 4, 1≦m≦M, M is the maximum retransmission number defined by the system.

Step 703: same as Step 403 in application scene 1.

Another solution according to the present invention can also be implemented as follows as an application scene 5:

In place of TDD UL/DL configuration 0, configuration 6 is used in PUSCH RTT period of not being 10 ms for backwards compatibility of the system. UE detects PDCCH with UL-Grant in downlink sub-frames possibly having UL-Grant. If UL-Grant is in sub-frames #0, #1, #6 and #9, then synchronous HARQ timing relation of PUSCH being scheduled is determined based on bit value of UL-DAI in UL-Grant and the position of UL-Grant, and if in other sub-frames, it is determined based on the sub-frame position of UL-Grant, with specific steps as follows:

Step 801: grouping in Option D, that is:

Group 1: TDD UL/DL configuration 6;

Group3: TDD UL/DL configurations 1, 2, 3, 4, and 5.

Step 802: UE detects PDCCH in the sub-frames possibly in uplink scheduling to acquire UL-Grant, here the possible sub-frames in uplink scheduling means #0, #1, #3, #4, #5, #6, #8 and #9. If UL-Grant is in sub-frames #0, #1, #6 and #9, then synchronous HARQ timing relation of PUSCH being scheduled is determined based on bit value of UL-DAI in UL-Grant and the position of UL-Grant, and if in other sub-frames, i.e., #3, #4, #5 or #8, it is determined based on the sub-frame position of UL-Grant, with specific steps as follow:

(1) Specific sub-step (1) in Step 403

(2) re-defining the meaning of UL-DAI in UL-Grant in sub-frames 0, 1, 6 and 9 as follows:

If the bit value of UL-DAI is “00”, “01” or “10”, then it's Group 2, i.e., TDD UL/DL configurations 1, 2, 3, 4, or 5; above three bit values have same definitions as in LTE and LTE-A, indicating the number of downlink sub-frames being scheduled in the downlink sub-frames bound with the uplink sub-frames being scheduled; these three bits have specific values:

TABLE 5

| Bit value of UL-DAI | Corresponding values |
|---|---|
| 0, 0 | 1, 4 or 7 |
| 0, 1 | 2, 5 or 8 |
| 1, 0 | 3, 6 or 9 |

Table 5 specific values corresponding to bit value of UL-DAI

If bit value of UL-DAI is “11”, then it's Group 1, i.e., TDD UL/DL configuration 6.

(3) If UE detects UL-Grant in sub-frames 0, 1, 6 or 9, which group TDD UL/DL configurations in a cell belong to is determined based on above mentioned (2). If UL-Grant is in sub-frames 3, 4 and 8, then it's Group 2, if in sub-frames 5, then it's Group 1.

(4) For Group 1, synchronous HARQ timing relation of PUSCH is same as that of configuration 6 in LTE and LTE-A, as shown in configuration 0 in Tables 2 and 3 in Background part. For Group 2, If UE detects UL-Grant in sub-frame n, the PUSCH being scheduled is sent in sub-frame n+k, and synchronous transmission of HARQ is carried in 10 ms of HARQ RTT, that is to say, PHICH is received in sub-frame n+10. If non-adaptive retransmission occurs to PUSCH, UE will transmit the mth non-adaptive retransmission in sub-frame n+10×m+k, and receive PHICH in the mth retransmissions in sub-frame n+10×(m+1), here, k is as in Table. 4, 1≦m≦M, M is the maximum retransmission number defined by the system.

Step 803: same as Step 403 in application scene 1.

Another solution according to the present invention can also be implemented as follows as an application scene 6:

Step 901: grouping in Option D, that is:

Group 1: TDD UL/DL configuration 6;

Group3: TDD UL/DL configurations 1, 2, 3, 4, and 5.

Step 902: a new DCI format is defined based on DCI 0 in LTE and LTE-A, adding 1 bit on all DCI 0 (hereinafter referred as new bit). The groups are indicated by the values of the new bit, for example, “0” indicates group 1, “1” indicates group 2. Or the DCI format in application scene remains, adding two bits on all DCI 0 (hereinafter referred as new bit). The groups are indicated by the values of new bits, for example, “00” indicates group 1, “11” indicates group 2. The current grouping is determined by the bit value of the new bits in the newly defined DCI. If it's group 1, synchronous HARQ timing relation of PUSCH is the same as that of TDD UL/DL configuration 6 in LTE and LTE-A. If it's group 2, synchronous HARQ timing relation of PUSCH is determined in the same way as the Group 2 in application scene 1.

Step 903: same as Step 403 in application scene 1.

In the technical solution of the present invention, 7 TDD UL/DL configurations, defined in existing LTE/LTE-A, are grouped based on the period of round trip time (RTT) of PUSCH or other criteria. eNB schedules PUSCH via signaling, and meantime indicates the current grouping information to UE; UE determines the scheduled synchronous HARQ timing relation of PUSCH with reference to synchronous HARQ timing relation of PUSCH of TDD UL/DL configurations in the group. The grouping information of existing 7 UL/DL configurations is only to indicate to UE synchronous HARQ timing relation of PUSCH, not to limit UL/DL sub-frames working in the current system. In the case that UE acquires the information about the scheduling of PUSCH and grouping of current TDD UL/DL configurations by the signaling sent by eNB, even if the UL/DL sub-frames of TDD UL/DL configurations current in the system are different than that of any of the groups, UE is able to determine synchronous HARQ timing relation of PUSCH scheduled based on synchronous HARQ timing relation of PUSCH of TDD UL/DL configurations in the group and the method of present invention.

It is understood by those skilled in the art that all steps or a part thereof of above method may be implemented via programs to instruct related hardwares. Said program may be stored in a computer readable medium, when executed, comprises any of steps of the method or combinations thereof of the embodiments.

In addition, individual functional units in various embodiments of the present invention may be integrated in processing module, or physically present as single unit, or populated into a single module via two or more units. Above integrated modules may be implemented either by in hardware or in the software function module. Said integrated module, when embodied as software function module and sold or used as independent products, may be stored in a computer readable storage medium.

The above mentioned storage medium may be ROM, disk or CDs, etc.

The above description is only the part of the embodiments of the present invention. It should be noted that for those skilled in the art that various modifications and changes may be made without departing from the principle of the present invention, and those modifications and changes are within the scope sought to be protected by this invention.

1. A method for performing an uplink scheduling by an evolved Node B (eNB) in a wireless communication system, the method comprising:
transmitting signaling information to a User Equipment (UE), the signaling information including synchronous hybrid automatic repeat request (HARQ) timing information of an uplink data channel, wherein the synchronous HARQ timing information is determined based on information of grouping of uplink and downlink configurations; and
receiving data on the uplink data channel.

2. The method of claim 1, wherein the grouping of uplink and downlink configurations comprises grouping the uplink and downlink configurations based on period characteristics of a round trip time (RTT) of time division duplex (TDD) uplink and downlink configurations, the RTT being a RTT of the uplink data channel.

3. The method of claim 2, wherein the grouping of the uplink and downlink configurations comprises one of:
option A: grouping seven TDD uplink and downlink configurations based on the period characteristics of the RTT of the uplink data channel into the first group including TDD uplink and downlink configurations 1, 2, 3, 4, and 5 with 10 ms of the RTT, and the second group including TDD uplink and downlink configurations 0 and 6 with the RTT not being 10 ms;
option B: grouping seven TDD uplink and downlink configurations based on the period characteristics of the RTT of the uplink data channel into the first group including TDD uplink and downlink configurations 1, 2, 3, 4, and 5 with the RTT of 10 ms, the second group including TDD uplink and downlink configuration 0 with the RTT not being 10 ms; and the third group including TDD uplink and downlink configuration 6 with the RTT not being 10 ms;
option C: grouping seven TDD uplink and downlink configurations based on the period characteristics of RTT of the uplink data channel into the first group including TDD uplink and downlink configurations 1, 2, 3, 4, and 5 with 10 ms of RTT, and the second group including TDD uplink and downlink configuration 0 with RTT not being 10 ms; and
option D: grouping seven TDD uplink and downlink configurations based on the period characteristics of RTT of the uplink data channel into the first group including TDD uplink and downlink configurations 1, 2, 3, 4, and 5 with 10 ms of RTT, and the second group including TDD uplink and downlink configuration 6 with RTT not being 10 ms.

4. The method of claim 3, wherein the UE determines synchronized HARQ timing of the uplink data channel according to the synchronous HARQ timing information based on the TDD uplink and downlink configurations within groups corresponding to one of the option A to the option D.

5. The method of claim 3, wherein the eNB indicates the grouping of the uplink and downlink configurations based on a bit values in an uplink index or an uplink downlink assignment index (UL-DAI) of uplink grant.

6. The method of claim 4, wherein:
for the options A, B or C:
when the bit value is “00”, a group according to current TDD uplink and downlink configuration is the first group;
when the bit values is “01”, “10” or “11”, a group according to current TDD uplink and downlink configuration is the second group;
for option D:
when the bit values is “01”, “01” or “10”, a group according to current TDD uplink and downlink configuration is the first group;
when the bit value is “11”, a group according to current TDD uplink and downlink configuration is the second group.

7. The method of claim 3, wherein the eNB indicates the information of the group using a bit value corresponding to a transmit power control (TPC) command in downlink control information (DCI) format 0.

8. The method of claim 3, wherein the eNB defines a DCI format with a bit value in DCI format 0 for indicating the information of the grouping.

9. A method for performing an uplink scheduling by a User Equipment (UE) in a wireless communication system, the method comprising:
receiving signaling information from an evolved Node B (eNB), the signaling information including synchronous hybrid automatic repeat request (HARQ) timing information of an uplink data channel, wherein the synchronous HARQ timing information is determined based on information of grouping of uplink and downlink configurations; and
transmitting data on the uplink data channel.

10. The method of claim 9, wherein the grouping of the uplink and downlink configurations is performed based on period characteristics of a Round Trip Time (RTT) of time division duplex (TDD) uplink and downlink configurations.

11. The method of claim 10, wherein the grouping uplink and downlink configurations comprises one of:
option A: grouping seven TDD uplink and downlink configurations based on period characteristics of the RTT of the uplink data channel into the first group including TDD uplink and downlink configurations 1, 2, 3, 4, and 5 with 10 ms of the RTT, and the second group including TDD uplink and downlink configurations 0 and 6 with the RTT not being 10 ms;
option B: grouping seven TDD uplink and downlink configurations based on the period characteristics of the RTT of the uplink data channel into the first group including TDD uplink and downlink configurations 1, 2, 3, 4, and 5 with 10 ms of the RTT, the second group including TDD uplink and downlink configuration 0 with the RTT not being 10 ms; and the third group including TDD uplink and downlink configuration 6 with the RTT not being 10 ms;
option C: grouping seven TDD uplink and downlink configurations based on the period characteristics of the RTT of the uplink data channel into the first group including TDD uplink and downlink configurations 1, 2, 3, 4, and 5 with 10 ms of the RTT, and the second group including TDD uplink and downlink configuration 0 with the RTT not being 10 ms; and
option D: grouping seven TDD uplink and downlink configurations based on the period characteristics of the RTT of the uplink data channel into the first group including TDD uplink and downlink configurations 1, 2, 3, 4, and 5 with 10 ms of the RTT, and the second group including TDD uplink and downlink configuration 6 with the RTT not being 10 ms.

12. The method of claim 11, wherein the UE obtains the information of the grouping based on the bit value of an uplink index or an uplink downlink assignment index (UL-DAI) of uplink-grant.

13. The method of claim 12, wherein:
for the options A, B or C:
when the bit value is “00”, a group according to current TDD uplink and downlink configuration is the first group;
when the bit values is “01”, “10” or “11”, a group according to current TDD uplink and downlink configuration is the second group;
for option D:
when the bit values is “01”, “01” or “10”, a group according to current TDD uplink and downlink configuration is the first group;
when the bit value is “11”, a group according to current TDD uplink and downlink configuration is the second group.

14. (canceled)

15. The method of claim 11, wherein the UE determines the information of the grouping based on a bit value defined in DCI format 0.

16. An evolved Node B (eNB) for performing an uplink scheduling in a wireless communication system, the eNB comprising:
a transceiver configured to transmit and receive a signal over a wireless network; and
a controller configured to control operations of transmitting signaling information to a User Equipment (UE), the signaling information including synchronous hybrid automatic repeat request (HARQ) timing information of an uplink data channel, wherein the synchronous HARQ timing information is determined based on information of grouping of uplink and downlink configurations, and receiving data on the uplink data channel.

17. (canceled)

18. A User Equipment (UE) for performing an uplink scheduling in a wireless communication system, the UE comprising:
a transceiver configured to transmit and receive a signal over a wireless network; and
a controller configured to control operations of receiving signaling information from an evolved Node B (eNB), the signaling information including synchronous Hybrid Automatic Repeat request (HARQ) timing information of uplink data channel, wherein the synchronous HARQ timing information is determined based on information of grouping of uplink and downlink configurations, and transmitting PUSCH information to the eNB.

19. (canceled)

20. The eNB of claim 16, wherein the controller is configured to control grouping the uplink and downlink configurations based on period characteristics of a round trip time (RTT) of time division duplex (TDD) uplink and downlink configurations, the RTT being a RTT of the uplink data channel.

21. The eNB of claim 20, wherein the grouping of the uplink and downlink configurations comprises one of:
option A: grouping seven TDD uplink and downlink configurations based on the period characteristics of the RTT of the uplink data channel into the first group including TDD uplink and downlink configurations 1, 2, 3, 4, and 5 with 10 ms of the RTT, and the second group including TDD uplink and downlink configurations 0 and 6 with the RTT not being 10 ms;
option B: grouping seven TDD uplink and downlink configurations based on the period characteristics of the RTT of the uplink data channel into the first group including TDD uplink and downlink configurations 1, 2, 3, 4, and 5 with the RTT of 10 ms, the second group including TDD uplink and downlink configuration 0 with the RTT not being 10 ms; and the third group including TDD uplink and downlink configuration 6 with the RTT not being 10 ms;
option C: grouping seven TDD uplink and downlink configurations based on the period characteristics of RTT of the uplink data channel into the first group including TDD uplink and downlink configurations 1, 2, 3, 4, and 5 with 10 ms of RTT, and the second group including TDD uplink and downlink configuration 0 with RTT not being 10 ms; and
option D: grouping seven TDD uplink and downlink configurations based on the period characteristics of RTT of the uplink data channel into the first group including TDD uplink and downlink configurations 1, 2, 3, 4, and 5 with 10 ms of RTT, and the second group including TDD uplink and downlink configuration 6 with RTT not being 10 ms.

22. The eNB of claim 21, wherein the UE determines synchronized HARQ timing of the uplink data channel according to the synchronous HARQ timing information based on the TDD uplink and downlink configurations within groups corresponding to one of the option A to the option D.

23. The eNB of claim 21, wherein the controller is configured to indicate the grouping of the uplink and downlink configurations based on a bit value in an uplink-index or an uplink downlink assignment index (UL-DAI) of uplink-grant.

24. The eNB of claim 22, wherein:
for the options A, B or C:
when the bit value is “00”, a group according to current TDD uplink and downlink configuration is the first group;
when the bit values is “01”, “10” or “11”, a group according to current TDD uplink and downlink configuration is the second group;
for option D:
when the bit values is “01”, “01” or “10”, a group according to current TDD uplink and downlink configuration is the first group;
when the bit value is “11”, a group according to current TDD uplink and downlink configuration is the second group.

25. The eNB of claim 21, wherein the controller is configured to indicate the information of the grouping using a bit value corresponding to a transmit power control (TPC) command in downlink control information (DCI) format 0.

26. The eNB of claim 21, wherein the controller is configured to define a DCI format with a bit value in DCI format 0 for indicating the information of the grouping.

27. The UE of claim 18, wherein the grouping of the uplink and downlink configurations is performed based on period characteristics of a Round Trip Time (RTT) of time division duplex (TDD) uplink and downlink configurations.

28. The UE of claim 27, wherein the grouping uplink and downlink configurations comprises one of:
option A: grouping seven TDD uplink and downlink configurations based on period characteristics of the RTT of the uplink data channel into the first group including TDD uplink and downlink configurations 1, 2, 3, 4, and 5 with 10 ms of the RTT, and the second group including TDD uplink and downlink configurations 0 and 6 with the RTT not being 10 ms;
option B: grouping seven TDD uplink and downlink configurations based on the period characteristics of the RTT of the uplink data channel into the first group including TDD uplink and downlink configurations 1, 2, 3, 4, and 5 with 10 ms of the RTT, the second group including TDD uplink and downlink configuration 0 with the RTT not being 10 ms; and the third group including TDD uplink and downlink configuration 6 with the RTT not being 10 ms;
option C: grouping seven TDD uplink and downlink configurations based on the period characteristics of the RTT of the uplink data channel into the first group including TDD uplink and downlink configurations 1, 2, 3, 4, and 5 with 10 ms of the RTT, and the second group including TDD uplink and downlink configuration 0 with the RTT not being 10 ms; and
option D: grouping seven TDD uplink and downlink configurations based on the period characteristics of the RTT of the uplink data channel into the first group including TDD uplink and downlink configurations 1, 2, 3, 4, and 5 with 10 ms of the RTT, and the second group including TDD uplink and downlink configuration 6 with the RTT not being 10 ms.

29. The UE of claim 28, wherein the controller is configured to obtain the information of the grouping based on the bit value of an uplink-index or an uplink downlink assignment index (UL-DAI) of uplink-grant.

30. The UE of claim 29, wherein:
for the options A, B or C:
when the bit value is “00”, a group according to current TDD uplink and downlink configuration is the first group;
when the bit values is “01”, “10” or “11”, a group according to current TDD uplink and downlink configuration is the second group;
for option D:
when the bit values is “01”, “01” or “10”, a group according to current TDD uplink and downlink configuration is the first group;
when the bit value is “11”, a group according to current TDD uplink and downlink configuration is the second group.

31. The UE of claim 28, wherein the controller is configured to determine the information of the grouping based on a bit value defined in DCI format 0.
